(19) United States
(12) Patent Application Publication
(10) Pub. No.: US 2005/0267000 A1
(43) Pub. Date: Dec. 1, 2005

(54) Method for producing substantially planar films

(76) Inventor: George L. Kerber, San Diego, CA (US)

Correspondence Address: KATTEN MUCHIN ROSENMAN LLP, 525 WEST MONROE STREET, CHICAGO, IL, 60661-3693, US

(21) Appl. No.: 11/114,931

(22) Filed: Apr. 26, 2005

Related U.S. Application Data
(63) Continuation of application No. 08/760,625, filed on Dec. 4, 1996.

(51) Int. Cl. H01G 2/00

(52) U.S. Cl. 505/190

(57) ABSTRACT

This present invention is directed to a method for producing very smooth, substantially planar films for use in the manufacture of high performance superconductive integrated circuits (ICs) and in the fabrication of tunnel junctions. The method of the present invention applies a low frequency AC bias voltage to a substrate and uses a sputtered target material, such as silicon dioxide, to effectively produce very smooth and substantially planar films, and in particular, oxide films and metal films. The method produces films, such as oxide films, on a bare or uncoated substrate, the films having a surface roughness of less than about 0.1 nanometer. The method also produces films on a conductive or coated substrate, the films having a surface roughness of less than about 1.0 nanometer.

### BACKGROUND OF THE INVENTION

1. Field of the Invention

This invention relates generally to a method for producing substantially planar films, and more particularly, to a method for producing very smooth, substantially planar films, such as oxide and metal films, for use in the manufacture of high performance superconductive integrated circuits (ICs) and in the fabrication of tunnel junctions.

2. Discussion of the Related Art

Thin films, such as oxide films and metal films, are used in the manufacture of superconductive integrated circuits (ICs), in the fabrication of tunnel junctions, and in related applications. It is desirable to form such films having a smooth, and planar or substantially planar surface, resulting in improved interconnect wiring reliability in integrated circuits, increased performance and yield and decreased subgap leakage in tunnel junctions, reduced defect density of the films, and improved step coverage.

Thin films may be formed on a bare or uncoated substrate, and may also be formed on a conductive or coated substrate. In the formation of thin films on a bare substrate, such as a silicon wafer, a suitable dielectric material, such as silicon dioxide (SiO₂), may be sputtered directly onto the substrate. It is known that sputter-deposited silicon dioxide is a good interlevel dielectric material for the manufacture of superconductive ICs, since it can be deposited at low temperatures and its defect density is low enough for medium scale ICs. However, due to its relatively poor step coverage, sputter-deposited SiO₂, alone, is not adequate for high yield, large scale IC fabrication processes. It is known that the use of high frequency, i.e., 13.56 MHz, RF (radio frequency) substrate bias and the use of substrate tuning during sputter deposition using SiO₂ has been shown to improve the step coverage and reduce some surface roughness. However, the use of high frequency RF substrate bias methods requires the use of an impedance matching network between the RF generator and the substrate in order to develop a bias at the substrate. The use of an impedance matching network is inconvenient because it must be tuned and is difficult to operate. Additionally, substrate tuning methods involve the use of a matching network to tune the substrate, and do not involve powering the substrate with RF energy. Substrate tuning methods do not provide as much flexibility as other methods, as there is a limited range over which the substrate can be tuned, and such methods are also inconvenient because of the complicated tuning network.

In the formation of thin films on a conductive substrate, i.e., a silicon wafer coated with a metal film or a superconductive film, a suitable dielectric material, such as silicon dioxide (SiO₂), may be deposited over the metal or superconductive film to form an insulating layer. In particular, niobium nitride (NbN) is a suitable metal film which can be deposited onto a substrate prior to sputter deposition of SiO₂. NbN metal films are important in the fabrication of tunnel junctions and complex superconductive ICs and are known for their high superconducting transition temperature (greater than 15 K (Kelvin)) and strong refractory nature. For example, a method for the production of high transition superconducting NbN films is disclosed in U.S. Pat. No. 4,726,890 to Thakoor et al. A method for the production of edge geometry superconducting tunnel junctions utilizing NbN is disclosed in U.S. Pat. No. 5,100,694 to Hunt et al. In addition, a method for fabricating niobium tunnel junctions is disclosed in, S. Hasuo, “High-Speed Josephson Integrated Circuit Technology,” IEEE Transactions on Magnetics, Vol. 25, No. 2, March 1989, pp. 740-749.

NbN films may also serve as the base electrode of tunnel junctions fabricated in thin film trilayers of niobium nitride/magnesium oxide/niobium nitride (NbN/MgO/NbN). Unwanted parasitic circuit inductances can be reduced by inserting a separate NbN ground plane below the trilayer of NbN/MgO/NbN. However, because the MgO tunnel barrier layer is on the order of 1 nanometer thick, any degree of surface roughness of the NbN base electrode degrades device performance. Thus, fabrication of high quality NbN tunnel junctions over a separate NbN ground plane has been difficult because of the surface roughness of thick NbN films and interlevel dielectrics, such as oxide films, and more particularly, sputter-deposited SiO₂ films. The use of thick NbN films which have a rough surface, in the fabrication of tunnel junctions, produces undesirable poor performance of the tunnel junctions.

Known methods for forming thin films, such as oxide and metal films, include sputter deposition, plasma deposition, and chemical vapor deposition. However, the surfaces of a substrate over which such thin films are formed by these known methods are generally too rough, and not smooth and planar enough for fabrication of superconductive ICs and tunnel junctions. For example, the surfaces may have peaks and valleys, pinholes, nodules, and other undesirable defects, which can be detected on a subnanometer (atomic) scale. Thus, when a thin film is formed over a rough substrate surface by one of these known methods, the surface of the resulting thin film covering the substrate is also rough and relatively uneven, on a subnanometer (atomic) scale.

In order to obtain very smooth and planar or substantially planar thin oxide or metal films, it is necessary that during the deposition process, the deposited film fills in the ridges and valleys on the deposition surface, so as to effectively planarize the rough deposition or substrate surface. In an attempt to accomplish this task, various known deposition methods have been proposed which apply a bias to the substrate to change the properties or morphology of the film growth.

Known methods exist which apply a direct current (DC) voltage bias alone to a substrate to grow metallic films. However, the application of a DC bias alone to a substrate, to which an oxide film is to be deposited on, is not effective in changing the morphology of the film because charge builds up on the oxide film as the deposition progresses and causes DC arcing to occur between the substrate and the ground.

In addition, as stated above, known methods exist which use a single high frequency (13.56 MHz) RF applied substrate bias or RF substrate tuning. However, such methods are inconvenient and require the use of an added impedance matching network in order to develop a bias at the substrate.

A method is disclosed in U.S. Pat. No. 4,816,126 to Kamoshida et al., for forming a planarized thin film in which a DC or RF bias voltage of greater than −700 V (Volts) is applied to the substrate. A method for forming silicon dioxide films is disclosed in, A. Mumtaz et al., “Radio Frequency Magnetron Sputtering of Radio Frequency Biased Quartz on a Scanning Pallet,” J. Vac. Sci. Technol. A 2 (2) (1984) pp. 237-240, which provides a substrate bias by substrate tuning or by applying an RF substrate bias of between zero and −120 Volts.

Although known processes may produce films having the appearance of a smooth surface, the films are relatively uneven and rough and have a number of defects, such as pinholes and nodules, on a subnanometer (atomic) scale, which affect the overall reliability and performance of the films in the manufacture of ICs, and more particularly, superconductive ICs.

Therefore, what is needed is a method for producing very smooth, substantially planar films (at the subnanometer scale) on a substrate, and in particular, oxide and metal films. The method of the present invention can be applied to the deposition of films, such as oxide and metal films, on a substrate to significantly reduce the surface roughness to a thickness below that obtained with conventional RF (13.56 MHz) or DC substrate bias sputter deposition methods. In the present invention, it has been found that by applying to the substrate during the deposition of oxide or metal films, a low frequency AC (alternating current) bias voltage in the frequency range of about 10 KHz to about 100 KHz, and most preferably at the frequency of 40 KHz, the produced films have a very smooth and substantially planar surface. In one embodiment, the method of the present invention produces substantially planar films, such as oxide films, directly on a substrate, where the films have a surface roughness of less than about 0.1 nanometer. In another embodiment, the method of the present invention produces substantially planar films, such as oxide and metal films, on a conductive or coated substrate, where the films have a surface roughness of less than about 1.0 nanometer. The resulting surface roughnesses of the produced films of the present invention are significant reductions in surface roughnesses as compared to other similar films produced by known deposition methods.

In the present invention, application of a low frequency AC substrate bias during sputter deposition produces positive ion bombardment of the substrate and resputtering of the deposited material. When the deposition and removal rates are within a certain range, material deposited over steps tends to become smooth and over narrow metal lines tends to become level, locally planarizing the surface. Planarization and the reduction of surface roughness using low frequency bias sputtering is due to the fact that under ion bombardment, sloped features are resputtered at a higher rate than flatter areas because of the angular dependence of sputter yield which, for example, is maximum at about 65° for silicon and silicon dioxide. Defects, such as nodules and pinholes, are planarized and other material, which is not in ideal position on the surface of the film, is re-emitted under ion bombardment, leaving behind better quality material.

In addition, with the present invention, the use of a low frequency substrate bias is simpler to implement than a conventional RF bias for dielectric films because the use of a low frequency substrate bias eliminates the need for an RF matching network to the substrate. The use of an RF matching network to the substrate is inconvenient because it requires the additional step of tuning and is more difficult to operate.

In addition, the very smooth, substantially planar films produced by the method of the present invention provide a more efficient and higher yield fabrication of tunnel junctions. The use of smooth, substantially planar films in tunnel junctions also decreases subgap leakage (of current) in the tunnel junctions. For purposes of this application, the term “subgap leakage” means the amount of current which flows through and is measured at 3 mV (millivolts) for an NbN/MgO/NbN tunnel junction. In addition, the smooth, substantially planar films of the present invention can be used on NbN ground planes to reduce parasitic circuit inductances, and increase performance and provide higher speed operations of superconductive ICs.

Further, the use of a low frequency substrate bias in the present invention completely eliminates re-entrant oxide step over vertical structures, that is, when the oxide or metal film is grown on the substrate during deposition, the use of a low frequency bias prevents re-entrant oxide on the substrate from going back on itself and forming crevices or steps which are undesirable in the manufacture of ICs. For example, in the manufacture of ICs, when metal is coated onto a produced film formed without bias and which has crevices or re-entrant steps, the metal becomes trapped in the step areas and causes metal lines to short, thus diminishing interconnect wiring reliability and performance.

Further, in the present invention, with the application of a low frequency bias to the substrate, the intrinsic defect density is less than 1 per cm² for low frequency bias-sputtered oxide films compared to about 8 per cm², or greater, for sputter-deposited oxide films without substrate bias. For purposes of this application, the term “defect density” means a defect in the oxide or metal film which causes a circuit failure.

Further, the method of the present invention has the advantages of being efficient, low cost, and quick.

Thus, the present invention provides a method that produces very smooth and substantially planar thin films, such as oxide and metal films, for use in the manufacture of superconductive ICs, in the fabrication of tunnel junctions, and in related applications. Further features and advantages of the present invention will be discussed in detail below.

### SUMMARY OF THE INVENTION

In accordance with the teachings of the present invention, a method for producing very smooth and substantially planar films is disclosed. The method applies a low frequency alternating current (AC) bias voltage to a substrate during deposition to produce very smooth and substantially planar films having a surface roughness of less than about 0.1 nanometer, such as for oxide films deposited directly on a substrate, and films having a surface roughness of less than about 1.0 nanometer, such as for oxide and metal films deposited on a conductive or coated substrate.

According to one aspect of the present invention, a method for producing a substantially planar film is provided which comprises the steps of: positioning a substrate in a reaction chamber; providing a target material in the reaction chamber positioned in opposed relationship to the substrate; introducing a gas into the reaction chamber; applying a first source of power to the target at a sufficient energy to generate plasma from the gas; applying a second source of power having an AC bias voltage to the substrate, where the AC bias voltage has a frequency in the range of about 10 KHz to about 100 KHz; generating particles from the target for deposit onto the substrate; and, depositing an effective amount of the target particles onto the substrate to produce a substantially planar film on the substrate.

The method may further include the step of, prior to positioning of the substrate in the reaction chamber, the step of depositing a coating of metal film onto the substrate. The metal film may be comprised of niobium nitride (NbN), niobium (Nb), or another suitable metal. In addition, the method may further include the step of, prior to positioning of the substrate in the reaction chamber, the step of depositing a superconductive film onto the substrate. A superconductive film, such as yttrium barium copper oxide (YBCO), may be used.

The method may further include the step of patterning the substantially planar film for use in superconductive integrated circuits and in the fabrication of tunnel junctions.

The substrate which is positioned in the reaction chamber may comprise a material such as silicon, sapphire, quartz, or another suitable material. Preferably, the substrate is comprised of silicon. The target material may be comprised of a material, such as a dielectric or a metal. Preferably, the target is comprised of the dielectric silicon dioxide. The gas which is introduced into the reaction chamber may be argon, a combination of argon and oxygen, or a combination of argon and nitrogen. However, other suitable gases or combination of gases may also be used. The first source of power applied to the target may comprise an RF generator having a frequency in the range of about 1 MHz to about 100 MHz. Preferably, the frequency of the RF generator is 13.56 MHz. The second source of power applied to the substrate may preferably comprise a low frequency AC bias voltage in the range of about 10 KHz to about 100 KHz. More preferably, the AC bias voltage is in the range of about 30 KHz to about 50 KHz. Most preferably, the AC bias voltage is 40 KHz

The substantially planar film that is produced may have a surface roughness of less than about 1.0 nanometer. Preferably, for this aspect of the present invention, the substantially planar film that is produced has a surface roughness of less than about 0.1 nanometer. In addition, the substantially planar film that is produced is preferably an oxide film or a metal film. However, other suitable films may also be produced, depending on the target material selected.

The method of the present invention may be carried out preferably by sputter deposition and preferably at ambient temperature.

According to another aspect of the present invention, a method for producing a substantially planar film is provided, comprising the steps of: depositing a coating of metal film having a rough surface onto a substrate; positioning the coated substrate in a reaction chamber; providing a target material in the reaction chamber positioned in opposed relationship to the substrate; introducing a gas into the reaction chamber; applying a first source of power to the target at a sufficient energy to generate plasma from the gas; applying a second source of power having an AC bias voltage to the substrate, where the AC bias has a frequency in the range of about 10 KHz to about 100 KHz; generating particles from the target for deposit onto the coated substrate; and, depositing an effective amount of target particles onto the substrate to produce a substantially planar film on the substrate.

The method of this aspect of the invention may further include the step of patterning the substantially planar film for use in superconductive integrated circuits and in the fabrication of tunnel junctions. The metal film may be comprised of niobium nitride (NbN), niobium (Nb), or another suitable metal. Preferably, the metal film is comprised of niobium nitride (NbN). The substrate may comprise a material such as silicon, sapphire, quartz, or another suitable material. Preferably, the substrate is comprised of silicon. The target may comprise a material such as a dielectric or a metal. Preferably, the target material is the dielectric silicon dioxide. The gas which is introduced into the reaction chamber may De argon, a combination of argon and oxygen, or a combination of argon and nitrogen. However, other suitable gases or combination of gases may be used. The first source of power applied to the target may comprise an RF generator having a frequency in the range of about 1 MHz to about 100 MHz. Preferably, the RF generator has a frequency of 13.56 MHz. The second power source applied to the substrate may preferably comprise a low frequency AC bias voltage in the range of about 10 KHz to about 100 KHz. More preferably, the low frequency AC bias voltage is in the range of about 30 KHz to about 50 KHz. Most preferably, the low frequency AC bias voltage is 40 KHz. The substantially planar film produced has a surface roughness of less than about 1.0 nanometer, and preferably has a surface roughness of about 0.8 nanometer. The substantially planar film produced may be an oxide film or a metal film. However, other suitable films may be produced, depending on the selected target material. The method of this aspect of the invention may be carried out preferably by sputter deposition and at ambient, or room, temperature.

Other features and advantages of the present invention will become apparent from the following description of the drawings, detailed description of the invention, and claims, taken in conjunction with the accompanying drawings.

### BRIEF DESCRIPTION OF THE DRAWINGS

FIG. 1 is a schematic diagram of an apparatus for implementing the method of the present invention.

FIG. 2 is a photograph taken by a scanning electron microscope (SEM) showing silicon dioxide (SiO₂) step coverage over metal step without substrate bias.

FIG. 3 is a photograph taken by a scanning electron microscope (SEM) showing silicon dioxide (SiO₂) step coverage over metal step with substrate bias, in accordance with the method of the present invention.

FIG. 4 is a photograph taken by an atomic force microscope (AFM) showing a conventional sputter-deposited niobium nitride (NbN) film having a surface roughness of about 4.2 nanometers.

FIG. 5 is a photograph taken by an atomic force microscope (AFM) showing a low frequency bias-sputtered silicon dioxide (SiO₂) layer deposited on niobium nitride (NbN) film, in accordance with the method of the present invention, the SiO₂ film having a surface roughness of about 0.8 nanometer.

### DETAILED DESCRIPTION OF THE PREFERRED EMBODIMENTS

The following description of the preferred embodiments of the invention are merely exemplary in nature and are in no way intended to limit the invention or its applications or uses.

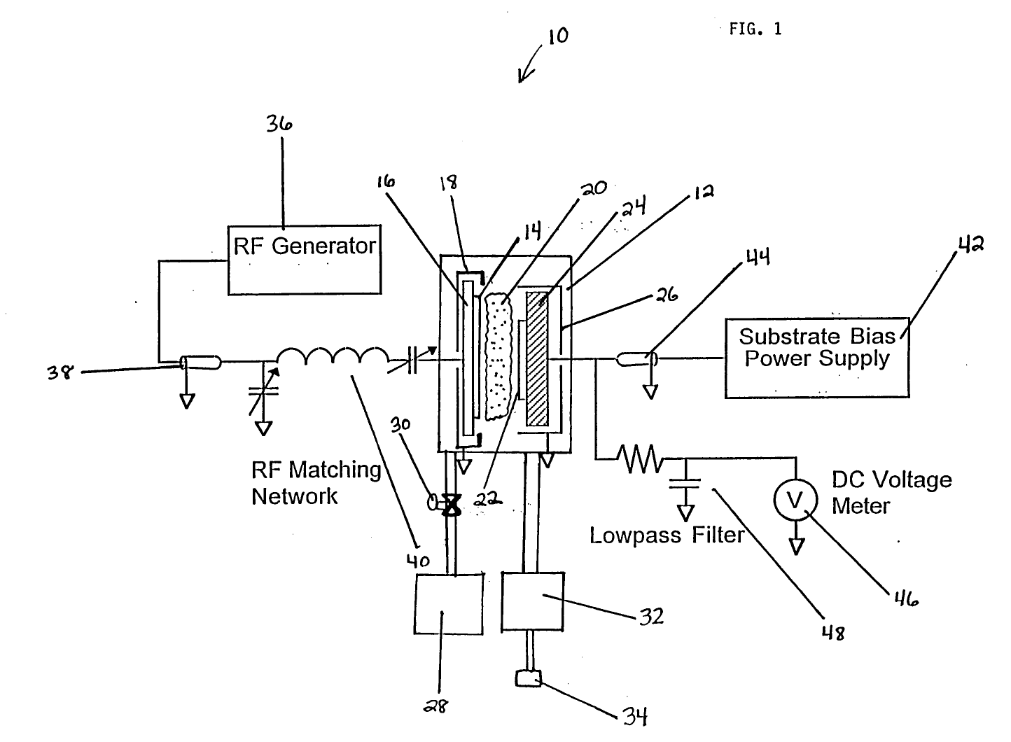

Prior to the description of the preferred embodiments of the present invention, an example of an apparatus adapted to implement the method of the present invention will be described with reference to FIG. 1.

In FIG. 1, a conventional sputter deposition apparatus 10 (manufactured by TRW Inc.) is shown. The apparatus 10 includes a vacuum reaction chamber 12 where sputter deposition and formation of the smooth and substantially planar films takes place. Disposed within the reaction chamber 12 is a target 14 which is mounted to a sputter gun 16 that is fixed to an inside portion of the chamber 12. The target 14 may be comprised of a material, such as a dielectric or a metal. Preferably, the target 14 is comprised of the dielectric silicon dioxide. The preferred silicon dioxide target 14 used in an embodiment of the present invention has a diameter of 15.2 cm, a thickness of 6.4 mm, and a purity of 99.995%. The target 14 and sputter gun 16 are partially surrounded by a first ground shield 18. The first ground shield 18 is preferably comprised of metal and is designed to confine a plasma 20 or glow discharge which is generated from a gas introduced into the reaction chamber to an area near the target 14, and to prevent sputtering of unwanted material not related to the target material. For the purposes of this application, the term “plasma” means partially ionized gas atoms or molecules consisting of equal numbers of positive and negative charges and some unionized neutral particles. The target 14 and sputter gun 16 are water cooled at ambient, or room, temperature of about 25° C. (Celsius) during the sputter deposition method.

A substrate 22 is mounted to a substrate holder 24 which is disposed within and fixed to an inside portion of the chamber 12. The substrate 22 may be comprised of a material such as silicon, sapphire, quartz, or another suitable material. Preferably, the substrate 22 is comprised of silicon. The preferred silicon substrate 22 used in an embodiment of the present invention has a diameter of 7.5 cm and a thickness in the range of about 0.25 mm to about 0.76 mm. When the apparatus 10 is in operation and during deposition, the substrate 22 is disposed in opposed relationship to the target 14. The distance between the substrate 22 and the target 14 during deposition is typically in the range of about 2.5 cm to about 25 cm, depending on the desired rate of deposition. A shutter (not shown) may be positioned between the substrate 22 and the target 14, and may be adjusted to an opened or closed position to expose or shield, respectively, the substrate 22 prior to deposition. The substrate holder 24 is water cooled at ambient, or room, temperature of about 25° C. during the deposition method, so as to maintain the substrate 22 at room temperature during the method. The substrate holder 24 is coupled to and partially surrounded by a second ground shield 26. The second ground shield 26 is preferably comprised of metal and is designed to confine the plasma 20 or glow discharge to the substrate 22 and to prevent sputtering of unwanted material which could contaminate the deposited films.

A vacuum pump 28 is attached to the reaction chamber 12. The vacuum pump 28 is used to initially evacuate the chamber 12 to a background pressure of less than 3×10⁻⁷ Torr, and preferably to a pressure of about 1×10⁻⁷ Torr. The vacuum pump 28 has a throttle valve 30 which controls the pumping speed of the vacuum pump 28 and, in turn, the vacuum condition of the chamber 12. A mass flow meter 32 is also attached to the chamber 12. The mass flow meter 32 measures the flow rate of a gas to be introduced into the chamber 12 during the operation of the apparatus 10. The mass flow meter 32 and a piezoelectric valve 34 are connected in a feedback loop with a pressure sensor (not shown) to maintain constant gas pressure. The gas which is introduced into the chamber 12 during deposition may be argon, a combination of argon and oxygen, a combination of argon and nitrogen, or another suitable gas or combination of gases. The preferred gas is argon. In the present invention, the pressure of argon is in the range of about 1 mTorr (milliTorr) to about 15 mTorr. The preferred pressure of argon is about 2.0 mTorr.

A first source of power 36 is electrically connected to the sputter gun 16 and target 14 via a first coaxial cable 38 and an RF matching network 40. When the apparatus 10 is in operation, the first source of power 36 supplies about 500 W (Watts) of power to the sputter gun 16. The power to the sputter gun 16 from the first source of power 36 may be varied by about 10% to about 20% to maintain a constant deposition rate over the useful life of the target 14. The first source of power 36 is preferably an RF (radio frequency) generator. Preferably, the RF generator has a frequency in the range of about 1 MHz (MegaHertz) to about 100 MHz. More preferably, the RF generator has frequency of 13.56 MHz.

A second source of power 42 is electrically coupled to the substrate holder 24 and to the substrate 22 via a second coaxial cable 44. The second source of power 42 is preferably an AC (alternating current) bias voltage power supply having a frequency in the range of about 10 KHz (KiloHertz) to about 100 KHz. More preferably, the frequency of the AC bias voltage is in the range of about 30 KHz to about 50 KHz. Most preferably, the frequency of the AC bias voltage is 40 KHz. For purposes of this application, the frequency of the AC bias voltage of the present invention is considered to be a low frequency as applicable to sputter deposition methods, and as compared to higher RF frequencies, such as 13.56 MHz. The AC bias voltage is selected based on the size and mechanical configuration of the substrate 22, the substrate holder 24, and the second ground shield 26, as well as the desired film properties, such as smoothness and thickness uniformity. The second source of power 42 discharges a current in the range of about 2 mA (milliAmps) to about 1000 mA (milliAmps), and the preferred current is selected based on the size and mechanical configuration of the substrate 22, the substrate holder 24, and the second ground shield 26. The second source of power 42 may also have a direct current (DC) component which is measured by a DC voltage meter 46 and which is extracted from a lowpass filter 48. The DC component is to a certain extent dependent on the size and mechanical configuration of the substrate 22, the substrate holder 24, and the second ground shield 26. The DC component has a voltage in the range of about −65 V (Volts) to about −90 V (Volts). The preferred DC voltage is in the range of about −75 V to about −80 V. The AC bias voltage may be adjusted to maintain the DC voltage in the range of about −75 V to about −80 V. The DC component is monitored to obtain optimal surface smoothness and uniformity of the produced films.

A first embodiment of the present invention is directed to a smooth, substantially planar film produced on a bare or uncoated silicon substrate. When the first embodiment of the method of the present invention is produced using the apparatus 10 shown in FIG. 1, the substrate 22 is first mounted onto the substrate holder 24 and positioned in the reaction chamber 12 in opposed relationship to the target 14. The substrate 22 may be comprised of a material such as silicon, sapphire, quartz, or another suitable material. Preferably, the substrate 22 is comprised of silicon. The target may be comprised of a material such as a dielectric or a metal Preferably, the target 14 is comprises or the dielectric silicon dioxide (SiO₂). Silicon dioxide is a good interlevel dielectric material for the manufacture of superconductive ICs, since it can be deposited at low temperatures (room temperature) and has low defect density.

Once the substrate 22, preferably comprised of silicon, is mounted onto the substrate holder 24 and the chamber 12 is sealed, the chamber 12 is evacuated by the vacuum pump 28 to a pressure in the range of less than 3×10⁻⁷ Torr, and preferably to a pressure of about 1×10⁻⁷ Torr. After the chamber 12 is evacuated, a suitable gas is introduced into the chamber 12 through the mass flow meter 32 and piezoelectric valve 34. The gas used in the present invention may be argon, a mixture of argon and oxygen, a mixture of argon and nitrogen, or another suitable gas or combination of gases. The preferred gas is argon. The piezoelectric valve 34 and pressure sensor (not shown) maintain the gas in the chamber 12 at a suitable pressure. When argon gas is used in the method, the pressure is in the range of about 1 mTorr to about 15 mTorr, and preferably, the pressure is about 2.0 mTorr.

After the gas is introduced into the chamber 12 by the piezoelectric valve 34, the first source of power 36 is turned on, and power is electrically applied to the sputter gun 16 and to the target 14. The first source of power 34 supplies about 500 W of power to the sputter gun 16 and is preferably an RF voltage generator. Preferably, the RF generator has a frequency in the range of about 1 MHz to about 100 MHz. More preferably, the RF generator has a frequency of 13.56 MHz. When the sputter gun 16 is powered to a sufficient energy level, the plasma 20 or glow discharge from the argon gas is generated between the target 14 and the substrate 22.

Within approximately one minute of starting the RF generator and generating the plasma 20, the second source of power 42 is turned on. The second source of power 42 is preferably an AC bias voltage power supply having a frequency in the range of about 10 KHz to about 100 KHz. More preferably, the frequency is in the range of about 30 KHz to about 50 KHz. Most preferably, the frequency is 40 KHz. The current discharged by the second source of power 42 is in the range of about 2 mA (milliAmps) to about 1000 mA (milliAmps), and the preferred current is selected based on the size and mechanical configuration of the substrate 22, the substrate holder 24, and the second ground shield 26. The second source of power 42 may also have a DC component having a voltage in the range of about −65 V to about −90 V. The preferred DC voltage is in the range of about −75 V to about −80 V.

Silicon dioxide particles from the silicon dioxide target are deposited by ion bombardment of the target onto the surface of the silicon substrate. When the low frequency bias voltage is applied to the silicon substrate during sputter deposition, ion bombardment of the substrate for re-emission of some of the deposited material occurs, and some of the particles deposited on the substrate are also resputtered. The resputtering rate and the removal of the material at the surface of the substrate, relative to deposition, is an increasing function of substrate bias. When the deposition and removal rates are within a certain range, material deposited over steps tends to become smooth and over narrow metal lines tends to become level, locally planarizing the surface. Planarization and the reduction of surface roughness using bias sputtering is due to the fact that under ion bombardment, sloped features are resputtered at a higher rate than flatter areas because of angular dependence of sputter yield, which, for example, is maximum at about 65° for silicon and silicon dioxide. For purposes of this application, the phrase “sputter yield” means the number of atoms or molecules ejected from the target or substrate per incident ion. Defects such as nodules and pinholes are planarized, and other material, which is not in ideal position on the surface of the film, is re-emitted under ion bombardment, leaving behind better quality material.

During the sputtering process, particles of silicon dioxide, or another selected target material, are ejected from the target and are deposited onto the surface of the substrate for a sufficient period of time, depending on the thickness of the oxide film which is desired. With the application of a substrate bias, the silicon dioxide is resputtered, filling in any ridges on the surface of the substrate and substantially planarizing the substrate and resulting oxide film deposited on the substrate.

Once an effective amount of the target particles are deposited onto the substrate 22 and the desired thickness of the produced film is achieved, the first source of power 36 and the second sources of power 42 are turned off simultaneously, and the argon gas is pumped out of the chamber. For purposes of this application, the phrase “an effective amount of target particles” means that amount which during deposition effectively planarizes and smoothes the surface of a substrate or the surface of a coated substrate. The substrate 22 with the produced film deposited on the substrate 22 is then unloaded out of the chamber 12. Thereafter, the produced film may be patterned by lithography, etching, or another similar process, in preparation for the manufacture of superconductive ICs and the fabrication of tunnel junctions.

Typically, the resulting film stack of this embodiment comprises a substrate (silicon) having a thickness in the range of from about 0.25 mm to about 0.76 mm, and a silicon dioxide film deposited on the silicon substrate having a thickness of about 60 nm (nanometers) to about 1000 nm. The time of deposition is typically quick and depends on the thickness of the film desired. For example, to produce a film having a desired thickness of about 100 nm, with the apparatus 10 in FIG. 1, the time of deposition is about 10 minutes.

In this embodiment of the present invention, it was found that the use of a low frequency AC bias applied to the substrate, produced films, such as oxide films, directly on the substrate, where the oxide films have a surface roughness of less than about 0.1 nm (rms) (nanometer—root mean square), as measured by atomic force microscope (AFM).

Further embodiments of the invention may include, prior to the step of positioning the substrate 22 within the reaction chamber 12, the step of coating the substrate 22 with a metal film or a superconductive film, and in turn, using the method as described above to produce smooth, substantially planar films. Preferred metal films that may be used include niobium nitride, niobium, or other suitable metals. Preferred superconductive films that may be used include yttrium barium copper oxide or other suitable superconductive films. It was found that the use of a low frequency AC bias applied to the substrate produced substantially planar films, such as oxide or metal films, on the conductive or coated substrate having a surface roughness of less than 1.0 nm (rms), as measured by atomic force microscope (AFM).

Another embodiment of the present invention is provided where a metal film having a rough or substantially rough surface is initially deposited onto the substrate 22 in order to form a ground plane on the substrate 22. The metal film may be comprised of a material such as niobium nitride (NbN), niobium (Nb), or another suitable metal. Preferably, the metal film is comprised of niobium nitride (NbN). The substrate may be comprised of a material such as silicon, sapphire, quartz, or another suitable substrate material. The metal film, preferably NbN, may be applied to the substrate 22, preferably silicon, in a conventional sputter deposition machine (not shown). Typically, the thickness of the metal film deposited on the substrate is in the range of about 100 nm to about 1000 nm. Preferably, the metal film has a thickness in the range of about 300 nm to about 500 nm. The time period it takes to deposit the metal film onto the substrate depends on the type of deposition machine used and the desired thickness of the film, but the typical deposition time is about one (1) hour.

Once the desired thickness of metal film on the substrate is achieved and a conductive or coated substrate is formed, the coated substrate is removed from the deposition machine and transferred to another sputter deposition machine, such as the one shown in FIG. 1. The coated substrate is mounted onto the substrate holder 24 inside the reaction chamber 12 in opposed relationship to the target 14. Preferably, the target 14 is comprised of silicon dioxide, although another suitable dielectric or metal may be used. The pressure and temperature are adjusted accordingly and similar to that described above with the first embodiment. A gas, preferably argon, is introduced into the chamber through the mass flow meter 32 and piezoelectric valve 34.

After the gas is introduced into the chamber, the first source of power 36, preferably an RF generator, is turned on, and the sputter gun 16 is supplied with about 500 W of power. Plasma 20 from the gas is first generated between the target 14 and the substrate 22, and then the second source of power 42 is turned on. The second source of power 42 is preferably an AC bias voltage power supply having a frequency in the range of about 10 KHz to about 100 KHz. More preferably, the frequency is in the range of about 30 KHz to about 50 KHz. Most preferably, the frequency is 40 KHz. The first power source 42 provides RF power similar to that described above with the first embodiment, and may provide DC voltage similar to that described above with the first embodiment of the present invention.

The low frequency bias is applied to the substrate to change the properties or morphology of the film. Once the substrate is biased, particles of silicon dioxide, or another selected target material, are sputtered and resputtered onto the metal film coated on the substrate. During deposition and growth of the film, the silicon dioxide particles fill in the ridges and valleys which are present on the surface of the rough metal film to substantially planarize the rough surface of the metal film. Once an effective amount of the target particles are deposited onto the substrate for a sufficient amount of time, depending on the desired thickness of the film, the first and second sources of power are turned off simultaneously, and the argon gas is pumped out of the chamber.

The substrate with the produced film deposited on the substrate is then unloaded out of the chamber. Thereafter, the produced film may be patterned by lithography, etching, or another similar process, in preparation for the manufacture of superconductive ICs and the fabrication of tunnel junctions.

With this embodiment of the present invention, where silicon dioxide is used as the target material, the resulting film is an oxide film on a coated substrate. The low frequency substrate bias planarizes the underlying surface topology or microstructure of the NbN film itself and produces an insulating oxide surface with subnanometer (atomic) scale surface roughness. The produced oxide film has a surface roughness of less than about 1.0 nm (rms) (nanometer—root mean square), as measured by atomic force microscope (AFM). Preferably, the surface roughness is about 0.8 nm. The present invention may also produce metal films on a bare or coated substrate, depending on the target material that is selected.

Typically, after deposition, the resulting film stack of this embodiment comprises a substrate (silicon) having a thickness in the range of from about 0.25 mm to about 0.76 mm; a metal film layer, i.e., NbN, deposited over the substrate, having a thickness in the range of about 100 nm to about 1000 nm; and an oxide film layer, i.e., silicon dioxide, deposited over the metal film layer, having a thickness in the range of about 60 nm to about 1000 nm. With the method of the present invention, to produce an oxide film having a desired oxide thickness of about 150 nm and using the apparatus 10 in FIG. 1, the time of deposition is about 15 minutes.

In relating to NbN superconductive IC technology, low frequency bias-sputtered SiO₂ is used to planarize and to smooth the surface of the NbN ground plane layer in preparation for the fabrication of NbN/MgO/NbN tunnel junctions. High current density tunnel junctions, ranging from about 1000 A/cm² (Amps/cm²) to about 5000 A/cm^{2,}, have been fabricated over NbN ground planes up to 1000 nm thick that exhibit low subgap leakage (Vm approximately equal to 15 mV at 10 K) and high sumgap voltage (Vgap 4.4 mV at 10 K).

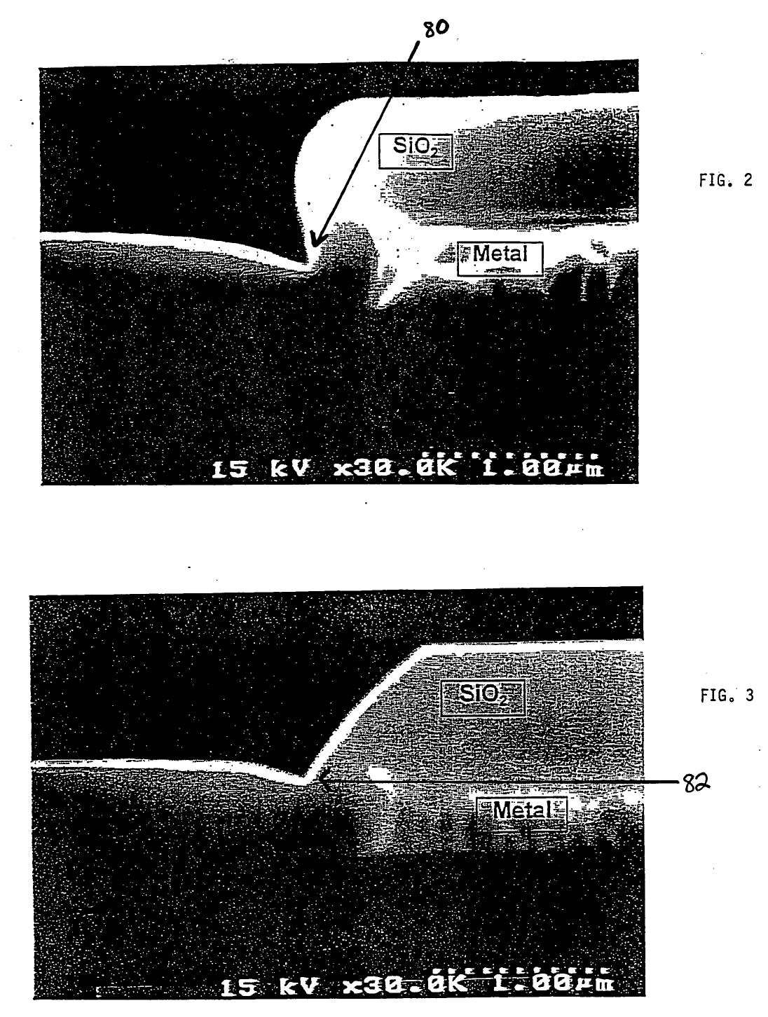

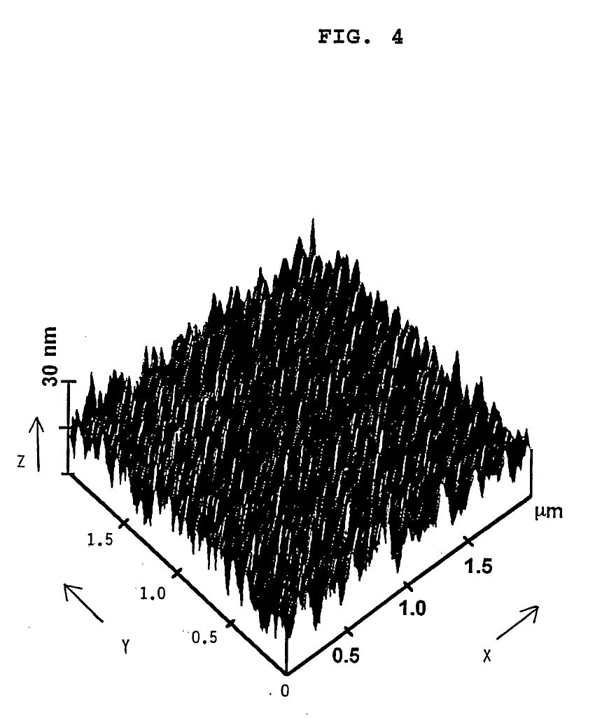

Referring to FIGS. 2 and 3, a comparison is made between silicon dioxide (SiO₂) step coverage without substrate bias (FIG. 2) and silicon dioxide (SiO₂) step coverage with a low frequency substrate bias (FIG. 3). Specifically, FIG. 2 shows a photograph taken by a scanning electron microscope (SEM) of SiO₂ step coverage over metal step without substrate bias. FIG. 2 shows a sharp crevice area 80 at the line edge where SiO₂ has gone back on itself (re-entrant) and can expose or inadequately protect the metal line edge. With the film produced in FIG. 2, in the manufacture of superconductive ICs, when metal is coated on top of such produced film, the metal will get trapped in the crevice area 80 and cause metal lines to short, thus decreasing the performance and reliability of the ICs.

In FIG. 3, a photograph taken by a scanning electron microscope (SEM) shows SiO₂ step coverage over step metal with application of a low frequency substrate bias, in accordance with the method of the present invention. The use of a low frequency substrate bias controls the slope angle of the step edge 82 to prevent the formation of undesirable crevices, such as the crevice area 80, shown in FIG. 2. The bias sputtered substrate, as shown in FIG. 3, eliminates reentrant oxide step, that is, the crevice area 80 is eliminated. This results in improved oxide quality and reduced defect density. In addition, in the manufacture of tunnel junctions and superconductive ICs, the yield is improved by the elimination of shorting between adjacent metal lines over oxide steps.

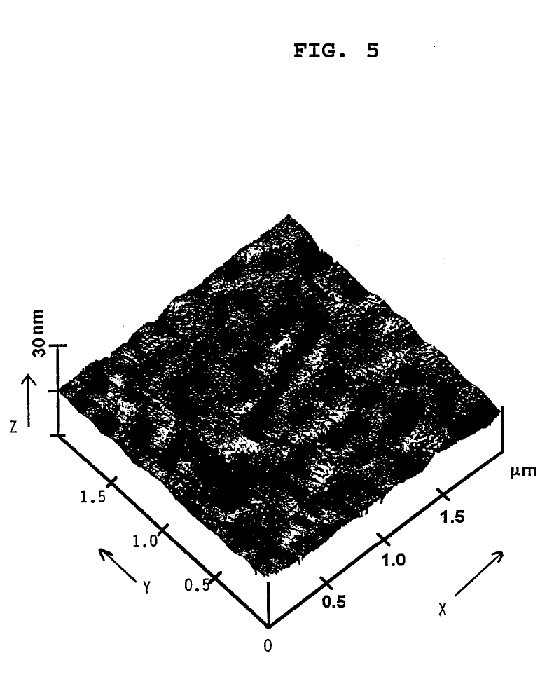

Referring to FIGS. 4 and 5, a comparison is made between a non-biased thick niobium nitride (NbN) ground plane film and a bias sputtered SiO₂ on a thick NbN ground plane film. Specifically, FIG. 4 shows a photograph taken by an atomic force microscope (AFM) showing a conventional sputter-deposited NbN film. The dimensions of the AFM scan include the following: x-axis=0.5 micrometer/division; Y-axis=0.5 micrometer/division; Z-axis=15 nanometer/division. The AFM scan reveals the fine grain columnar structure and peaks and valleys typical of thick NbN films. The surface roughness is measured at about 4.2 nm (rms) (nanometers—root mean square). The peak-to-valley roughness measures from about 15 nm to about 20 nm. The surface of the NbN ground plane film shown in FIG. 4 is undesirable for tunnel junction fabrication.

FIG. 5 is a photograph taken by an atomic force microscope (AFM) showing a low frequency bias-sputtered SiO₂ layer deposited on a thick NbN ground plane, in accordance with the method of the present invention, which is further described below in Example 1. The dimensions of the AFM scan include the following: X-axis=0.5 micrometer/division; Y-axis=0.5 micrometer/division; Z-axis=15 nanometer/division. The film stack comprises approximately a 200 nm layer of SiO₂, a 500 nm layer of NbN, and a bulk silicon substrate. FIG. 5 shows a dramatic reduction of the rapid spatial variation in the height of the columnar features of thick NbN films, such as that shown in FIG. 4. The low frequency, bias-sputtered SiO₂ effectively smoothes and planarizes the underlying surface topology, and the resulting SiO₂ surface roughness is measured at about 0.8 nm (rms) (nanometer—root mean square) The smooth, substantially planar oxide film shown in FIG. 5 is desirable for use in the fabrication of NbN/MgO/NbN tunnel junctions over an NbN ground plane.

### EXAMPLE 1

In this example, the apparatus shown in FIG. 1 was used for sputter deposition of a substrate coated with a niobium nitride (NbN) metal layer. First, a niobium nitride (NbN) metal film was sputter deposited in a conventional sputter deposition machine on a silicon wafer having a diameter of about 75 mm and having a thickness of about 0.5 mm. The NbN film used was a polycrystalline superconductive film having a Tc (transition temperature) of 15.4 K (Kelvin).

The coated silicon substrate had an NbN layer thickness of 500 nm. The roughness of the NbN layer was about 4.2 nm (rms) as measured by atomic force microscope. The peak-to-valley roughness of the NbN film was approximately 15 nm to 20 nm, as measured by atomic force microscope.

After, the substrate was coated with the NbN film layer, the coated substrate was mounted to a substrate holder within the reaction chamber of the apparatus 10 shown in FIG. 1 The substrate was positioned about 17.8 cm from a silicon dioxide target. The silicon dioxide target had a diameter of 15.2 cm, a thickness of 6.4 mm, and a purity of 99.995%. Argon gas was introduced into the reaction chamber at a pressure of 2.0 mTorr. An RF generator having a frequency of 13.56 MHz was turned on, and an RF power of 500 W was supplied to the sputter gun and target, generating an argon plasma or glow discharge. An AC substrate bias power supply having a frequency of 40 KHz was turned on, and a power of 20 W was supplied to the substrate. A DC self-bias of about −80 V was generated between the substrate holder and ground shield.

The coated substrate was sputtered with molecules of silicon dioxide at a deposition rate of about 0.16 nm/sec for about 20 minutes at about 25° C. After sufficient sputter deposition, the substrate with the deposited oxide film was removed from the chamber. As shown in FIG. 5, the resulting film stack comprised a 200 nm layer of SiO₂, a 500 nm layer of NbN, and a silicon substrate. The surface roughness of the SiO₂ layer was about 0.8 nm (rms), as measured by atomic force microscope. The film thickness had a nonuniformity of less than 2% across the 75 mm diameter silicon substrate.

The low frequency, bias-sputtered SiO₂ effectively smoothed and substantially planarized the underlying surface topology and microstructure of the NbN film, and dramatically reduced the rapid spatial variation in the height of the columnar features of the thick NbN film.

The foregoing discussion discloses and describes merely exemplary embodiments of the present invention. One skilled in the art will readily recognize from such discussion, and from the accompanying drawings and claims, that various changes, modifications and variation can be made therein without departing from the spirit and scope of the invention as defined in the following claims.

1. A method for producing a substantially planar film comprising the steps of:
positioning a substrate in a reaction chamber;
providing a target material in the reaction chamber positioned in opposed relationship to the substrate;
introducing a gas into the reaction chamber;
applying a first source of power to the target at a sufficient energy to generate a plasma from the gas;
applying a second source of power having an AC bias voltage to the substrate, wherein the AC bias voltage has a frequency in the range of about 10 KHz to about 100 KHz;
generating particles from the target for deposit onto the substrate; and,
depositing an effective amount of target particles onto the substrate to produce a substantially planar film on the substrate.

2. The method of claim 1 further including, prior to the step of positioning the substrate, the step of depositing a coating of metal film onto the substrate.

3. The method of claim 2 wherein the step of depositing a coating of metal film comprises depositing a material selected from the group consisting of niobium nitride and niobium.

4. The method of claim 1 further including, prior to the step of positioning the substrate, the step of depositing a coating of superconductive film onto the substrate.

5. The method of claim 1 further including the step of patterning the substantially planar film for use in superconductive integrated circuits and tunnel junctions.

6. The method of claim 1 wherein the step of positioning the substrate comprises positioning a material selected from the group consisting of silicon, sapphire, and quartz.

7. The method of claim 1 wherein the step of providing the target material comprises providing a material selected from the group consisting of a dielectric and a metal.

8. The method of claim 7 wherein the step of providing the target comprises providing a material comprising silicon dioxide.

9. The method of claim 1 wherein the step of introducing a gas comprises introducing a gas selected from the group consisting of argon, a combination of argon and oxygen, and a combination of argon and nitrogen.

10. The method of claim 1 wherein the step of applying a first source of power comprises applying an RF generator having a frequency in the range of about 1 MHz to about 100 MHz.

11. The method of claim 1 wherein the step of applying a first source of power comprises applying an RF generator having a frequency of 13.56 MHz.

12. The method of claim 1 wherein the step of applying a second source of power comprises applying an AC bias voltage having a frequency in the range of about 30 KHz to about 50 KHz.

13. The method of claim 1 wherein the step of applying a second source of power comprises applying an AC bias voltage having a frequency of 40 KHz.

14. The method of claim 1 wherein the step of depositing target particles onto the substrate comprises producing a substantially planar film having a surface roughness of less than about 1.0 nanometer.

15. The method of claim 1 wherein the step of depositing target particles onto the substrate comprises producing a substantially planar film having a surface roughness of less than about 0.1 nanometer.

16. The method of claim 1 wherein the step of depositing target particles onto the substrate comprises producing a substantially planar oxide film.

17. The method of claim 1 wherein the step of depositing target particles onto the substrate comprises producing a substantially planar metal film.

18. The method of claim 1 wherein the step of depositing particles onto the substrate comprises depositing by sputter deposition.

19. The method of claim 1 wherein the method is carried out at ambient temperature.

20. A method for producing a substantially planar film comprising the steps of:
depositing a coating of metal film having a rough surface onto a substrate;
positioning the coated substrate in a reaction chamber;
providing a target material in the reaction chamber positioned in opposed relationship to the substrate;
introducing a gas into the reaction chamber;
applying a first source of power to the target at a sufficient energy to generate a plasma from the gas;
applying a second source of power having an AC bias voltage to the substrate, wherein the AC bias voltage has a frequency in the range of about 10 KHz to about 100 KHz;
generating particles from the target for deposit onto the coated substrate; and,
depositing an effective amount of target particles onto the coated substrate to produce a substantially planar film on the substrate.

21. The method of claim 20 wherein the step of depositing a coating of metal film comprises depositing a material selected from the group consisting of niobium nitride and niobium.

22. The method of claim 20 further including the step of patterning the substantially planar film for use in superconductive integrated circuits and tunnel junctions.

23. The method of claim 20 wherein the step of positioning the coated substrate comprises positioning a material selected from the group consisting of silicon, sapphire, and quartz.

24. The method of claim 20 wherein the step of providing the target material comprises providing a material selected from the group consisting of a dielectric and a metal.

25. The method of claim 24 wherein the step of providing the target comprises providing a material comprising silicon dioxide.

26. The method of claim 20 wherein the step of introducing a gas comprises introducing a gas selected from the group consisting of argon, a combination of argon and oxygen, and a combination of argon and nitrogen.

27. The method of claim 20 wherein the step of applying a first source of power comprises applying an RF generator having a frequency in the range of about 1 MHz to about 100 MHz.

28. The method of claim 20 wherein the step of applying a first source of power comprises applying an RF generator having a frequency of 13.56 MHz.

29. The method of claim 20 wherein the step of applying a second source of power comprises applying an AC bias voltage having a frequency in the range of about 30 KHz to about 50 KHz.

30. The method of claim 20 wherein the step of applying a second source of power comprises applying an AC bias voltage having a frequency of 40 KHz.

31. The method of claim 20 wherein the step of depositing target particles onto the coated substrate comprises producing a substantially planar film having a surface roughness of less than about 1.0 nanometer.

32. The method of claim 20 wherein the step of depositing target particles onto the coated substrate comprises producing a substantially planar film having a surface roughness of about 0.8 nanometer.

33. The method of claim 20 wherein the step of depositing target particles onto the coated substrate comprises producing a substantially planar oxide film.

34. The method of claim 20 wherein the step of depositing target particles onto the coated substrate comprises producing a substantially planar metal film.

35. The method of claim 20 wherein the step of depositing particles onto the substrate comprises depositing by sputter deposition.

36. The method of claim 20 wherein the method is carried out at ambient temperature.

37. A deposition method for producing a substantially planar film on a substrate comprising the steps of:
positioning the substrate in a reaction chamber, wherein the substrate comprises a material selected from the group consisting of silicon, sapphire, and quartz;
providing a target in the reaction chamber positioned in opposed relationship to the substrate, wherein the target is a material selected from the group consisting of a dielectric and a metal;
introducing a gas into the reaction chamber, wherein the gas is selected from the group consisting of argon, a combination of argon and oxygen, and a combination of argon and nitrogen;
applying to the target a first source of power comprising RF energy, wherein the RF energy has a frequency in the range of about 1 MHz to about 100 MHz, and wherein the RF energy generates plasma from the gas;
applying to the substrate a second source of power having an AC bias voltage, wherein the AC bias voltage has a frequency in the range of about 10 KHz to about 100 KHz; and,
generating particles from the target for deposit onto the substrate; and,
sputter depositing an effective amount of the target particles onto the substrate to produce a substantially planar film onto the substrate, the film having a surface roughness of less than about 1.0 nanometer.

38. The method of claim 37 further including the step of patterning the substantially planar film for use in superconductive integrated circuits and tunnel junctions.

39. The method of claim 37 wherein the step of providing the target comprises providing a material comprising silicon dioxide.

40. The method of claim 37 wherein the step of depositing target particles onto the coated substrate comprises producing a substantially planar oxide film.

41. The method of claim 37 wherein the step of depositing target particles onto the coated substrate comprises producing a substantially planar metal film.

42. The method of claim 37 wherein the step of depositing target particles onto the coated substrate comprises producing a substantially planar film having a surface roughness of less than about 0.1 nm.

43. A method for producing a substantially planar film on a substrate comprising the steps of:
depositing a coating of metal film onto the substrate, wherein the metal film has a substantially rough surface and comprises a material selected from the group consisting of niobium nitride and niobium, and further wherein the substrate comprises a material selected from the group consisting of silicon, sapphire, and quartz;
positioning the coated substrate in a reaction chamber;
providing a target in the reaction chamber positioned in opposed relationship to the substrate, wherein the target is a material selected from the group consisting of a dieletric and a metal;
introducing a gas into the reaction chamber, wherein the gas is selected from the group consisting of argon, a combination of argon and oxygen, and a combination of argon and nitrogen;
applying to the target a first source of power comprising RF energy, wherein the RF energy has a frequency in the range of about 1 MHz to about 100 MHz, and wherein the RF energy generates plasma from the gas;
applying to the substrate a second source of power having an AC bias voltage to the substrate, wherein the AC bias voltage has a frequency in the range of about 10 KHz to about 100 KHz; and,
generating particles from the target for deposit onto the coated substrate; and,
sputter depositing an effective amount of the target particles onto the coated substrate to produce a substantially planar film on the substrate, the film having a surface roughness of less than about 1.0 nanometer.

44. The method of claim 43 further including the step of patterning the substantially planar film for use in superconductive integrated circuits and tunnel junctions.

45. The method of claim 43 wherein the step of providing the target comprises providing a material comprising the dielectric silicon dioxide.

46. The method of claim 43 wherein the step of depositing target particles onto the coated substrate comprises producing a substantially planar film having a surface roughness of about 0.8 nanometer.

47. The method of claim 43 wherein the step of depositing target particles onto the coated substrate comprises producing a substantially planar oxide film.

48. The method of claim 43 wherein the step of depositing target particles onto the coated substrate comprises producing a substantially planar metal film.
